(19) United States
(12) Patent Application Publication
(10) Pub. No.: US 2019/0152066 A1
(43) Pub. Date: May 23, 2019

(54) SPHERICAL MOVABLE DEVICE AND GESTURE RECOGNITION METHOD THEREOF

(71) Applicant: FAIRAPP INC., Gwangju (KR)

(72) Inventors: Hee Man PARK, Gwangju (KR); Sang Kyun NOH, Gwangju (KR); Yong Ju KIM, Gwangju (KR)

(21) Appl. No.: 16/250,792

(22) Filed: Jan. 17, 2019

Related U.S. Application Data
(63) Continuation of application No. PCT/KR2016/008392, filed on Jul. 29, 2016.

(30) Foreign Application Priority Data
Jul. 29, 2016 (KR) 10-2016-0097103

(51) Int. Cl. B25J 13/08; B25J 5/00; B25J 9/16; B25J 19/02

(52) U.S. Cl. CPC B25J 13/088; B25J 5/007; B25J 9/1664; B25J 19/02; B25J 9/1694

(57) ABSTRACT

The present disclosure relates to a spherical movable device and a gesture recognition method thereof. The spherical movable device has a drive body and a sphere loosely coupled with each other so that a contact region of the drive body where the drive body makes contact with the sphere may not make contact with the sphere depending on a movement, or a non-contact region of the drive body where the drive body does not make contact with the sphere may make contact with the sphere depending on a movement. Thus, since gestures of the spherical movable device may be recognized on the basis of abundant and reliable movement status information, various gestures may be recognized with high accuracy.

### CROSS-REFERENCE TO RELATED APPLICATIONS

The present application is a continuation of International Patent Application No. PCT/KR2016/008392, filed on Jul. 29, 2016, which claims priority to and benefit of Korean Patent Application No. 10-2016-0097103, filed on Jul. 29, 2016. The disclosures of the above-listed applications are hereby incorporated by reference herein in their entirety.

### FIELD OF THE INVENTION

The present disclosure relates to a spherical movable device and a gesture recognition method thereof; and, more particularly, to a spherical movable device for recognizing gesture applied to the device by external force during stoppage or movement of the device, and a gesture recognition method thereof.

The national research and development project related to this application is as follows.

Project number: S0702-18-1014

Government department: Ministry of Science and Technology Information and Communication

R&D management Agency: National IT Industry Promotion Agency

R&D project: Regional SW Industry Promotion Council support project

Research Project Title: Development of IoT platform technology for pet healthcare service

Contribution Ratio: 1/1

Managing department: FAIRAPP INC.

Project period: 2018 Jan. 1-2018 Dec. 31

### BACKGROUND OF THE INVENTION

A spherical movable device, which is also referred to as a spherical robot, can be designed to be hermetically protected from the harsh external environment. Further, the spherical movable device has interesting and unique features. Specifically, the sphere movable device can bounce when it collides with an obstacle and can operate holonomically. In robot engineering, a holonomic system indicates a robot that can move immediately in any direction without being affected by the direction in which it is currently facing.

The drive body of the spherical robot is disposed in the inner space of the sphere. The drive body needs to transmit driving force to rotate the sphere. An internal drive body of the spherical robot needs to move three-dimensionally independently from the sphere. The sphere needs to be connected to the internal drive body.

The driving principle of the spherical robot is basically classified into BCO (Barycenter Offset), ST (Shell Transformation), and COAM (Conservation of Angular Momentum).

Among them, the BCO is most frequently employed in the spherical robot. The BCO indicates an operation of moving the center of gravity of the robot to generate the movement required for the spherical robot. Assuming the sphere is in an equilibrium state, when the internal drive body of the sphere moves, the mass distribution of the sphere changes and the sphere rolls towards a new equilibrium position. At this time, it is possible to move the robot by using an appropriate control method.

As for a conventional spherical movable device, there is known an example in which a remote control car is provided as a drive body in an inner space of a sphere. This can be referred to as “decoupling” because the remote control vehicle is not connected to the sphere except for the wheels of the remote control vehicle. When the drive body moves, the sphere needs to move forward. In order to change the movement direction of the sphere, the direction of the inner drive body needs to be changed. When the drive body is floating in the air due to collision or vibration during the movement, the drive body and the sphere are in a non-contact state. Thus, the static friction force between the wheels of the drive body and the sphere disappears, and the spherical movable device loses momentum.

In order to overcome the above-described disadvantages caused by the non-contact, a spherical movable device in which the coupling force between the sphere and the drive body is enhanced has been proposed. This can be referred to as “coupling” because a ball bearing and a wheel of the drive body are compressed by a spring load system, so as to be in constant contact with the sphere. However, it is difficult to control the movement direction at a high speed, and it is difficult for the spherical movable device to move on a slope.

Further, conventional spherical movable devices have trouble recognizing gestures applied thereto by external force during stoppage or movement. In order to recognize gestures, movement status information such as acceleration indicating the movement status of the drive body or the like is measured and then based on such information, various gestures are recognized.

However, in the case of the decoupled spherical movable device, the drive body and the sphere are frequently in a non-contact state due to the external environment or the like during movement. Therefore, the measured movement status information is not reliable, which makes it difficult to cluster the movement status information to deal with various gestures.

In the coupled spherical movable device, the coupling state of the sphere and the drive body is constantly maintained during the movement and, thus, the measured movement status information is reliable. However, since some gestures have similar movement characteristics, the measured movement status information therefor are also similar, and therefore, it is difficult to cluster the movement status information to deal with various gestures.

### SUMMARY OF THE INVENTION

In view of the above, the present disclosure provides a spherical movable device and a gesture recognition method thereof, capable of accurately recognizing a gesture applied by external force during stoppage or movement by measuring abundant and reliable movement status information by loosely coupling a drive body and a sphere so that a contact region of the drive body where the drive body makes contact with the sphere may not make contact with the sphere depending on the movement, or a non-contact region of the drive body where the drive body does not make contact with the sphere may make contact with the sphere depending on the movement.

The objectives of the present disclosure are not limited to the above, and other objectives will be clearly understood by those skilled in the art.

### Effect of the Invention

In accordance with the embodiment of the present disclosure, the drive body and the sphere are loosely coupled so that a contact region of the drive body where the drive body makes contact with the sphere may not make contact with the sphere depending on the movement, or a non-contact region of the drive body where the drive body does not make contact with the sphere may make contact with the sphere depending on the movement. Thus, the movement characteristics change with more variety compared to the coupled sphere movable device in which the sphere and the drive body are compressed to be in constant contact with each other during movement. Accordingly, a relatively more abundant amount of movement status information, including an acceleration value and its change component, is measured. In addition, since the drive body and the sphere maintain the loosely coupled state during movement, movement status information, including the acceleration value measured at this time and its change component, is reliable.

Therefore, the gestures of the spherical movable device can be recognized based on the abundant and reliable movement status information, which makes it possible to recognize a variety of gestures with high accuracy.

### BRIEF DESCRIPTION OF THE DRAWINGS

FIG. 1 shows a configuration of a spherical movable device according to an embodiment of the present disclosure.

FIG. 2 is a block diagram of a control module included in the spherical movable device according to the embodiment of the present disclosure.

FIG. 3 is a flowchart for explaining a gesture recognition method of the spherical movable device according to one embodiment of the present disclosure.

### DETAILED DESCRIPTION OF THE EMBODIMENTS

Hereinafter, configurations and operations of embodiments will be described in detail with reference to the accompanying drawings. The following description is one of various patentable aspects of the present disclosure and may form a part of the detailed description of the present disclosure.

However, in describing the present disclosure, detailed descriptions of known configurations or functions that make the present disclosure obscure may be omitted.

The present disclosure may be modified and include various embodiments. Specific embodiments will be exemplarily illustrated in the drawings and described in the detailed description of the embodiments. However, it should be understood that they are not intended to limit the present disclosure to specific embodiments but rather to cover all modifications, similarities, and alternatives that are included in the spirit and scope of the present disclosure.

The terms used herein, including ordinal numbers such as “first” and “second” may be used to describe, and not to limit, various components. The terms simply distinguish the components from one another.

When it is said that a component is “connected” or “linked” to another component, it should be understood that the former component may be directly connected or linked to the latter component or a third component may be interposed between the two components.

Specific terms in the present disclosure are used simply to describe specific embodiments without limiting the present disclosure. An expression used in the singular encompasses the expression of the plural, unless it has a clearly different meaning in the context.

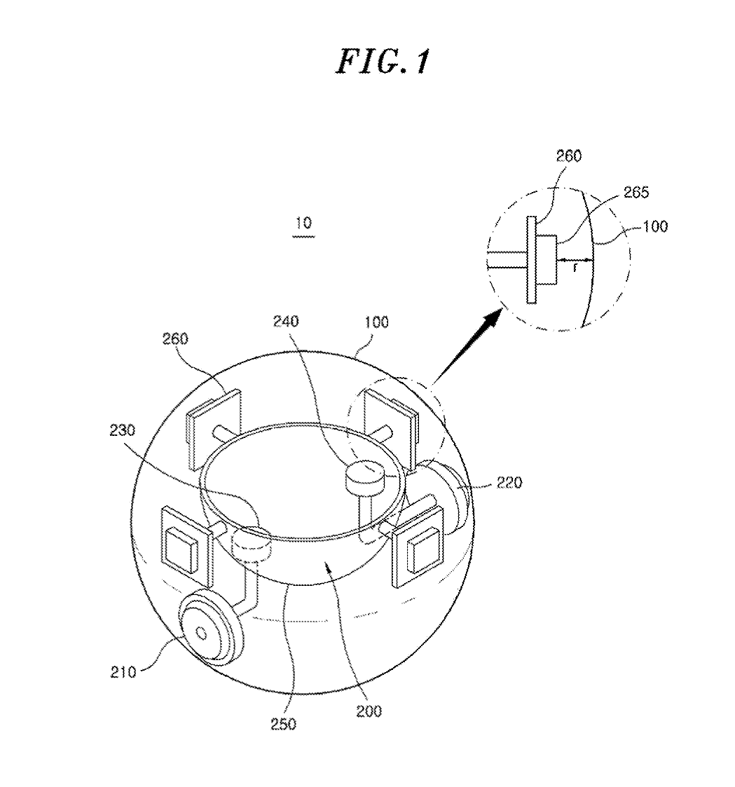

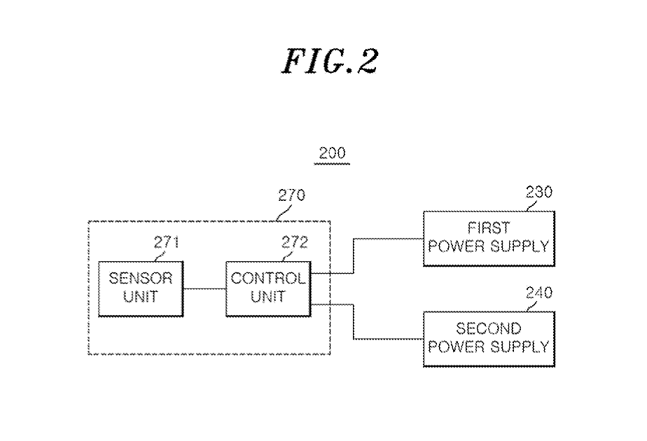

FIG. 1 shows a configuration of a spherical movable device 10 according to an embodiment of the present disclosure. FIG. 2 is a block diagram of a control module included in the spherical movable device 10 according to the embodiment of the present disclosure.

Referring to FIGS. 1 and 2, the spherical movable device 10 includes a sphere 100 and a drive body 200.

The sphere 100 has a hollow inner space. The drive body 200 can be disposed in the inner space. The sphere 100 rotates by driving force of the drive body 200. Here, the sphere 100 may have a complete spherical shape. However, the sphere 100 is not limited thereto, and may have an elliptical shape or an egg shape. Further, the sphere 100 may be made to rotate irregularly by forming a groove on a surface of the sphere 100 or by cutting a part of the sphere 100. In the present disclosure, such various examples are defined as a spherical shape, and the sphere 100 may be implemented as such various examples.

The drive body 200 provides driving force for rotating the sphere 100 through static friction force. Therefore, the drive body 200 includes a first wheel 210, a second wheel 220, a first power supply 230, and a second power supply 240.

The drive body 200 further includes a frame part 250 that forms a frame of the drive body 200. The frame part 250 may be made of plastic, metal or the like, but is not limited thereto.

The drive body 200 further includes a plurality of arm parts 260 that extends from the frame part 250 to be in contact with the sphere 100 during the rotation of the sphere 100 or be in a non-contact state with the sphere 100 by a separation distance r within a preset range. For example, the predetermined separation distance r between the arm part 260 and the inner surface of the sphere 100 may be 0.5 mm to 2 mm. The drive body 200 includes a contact region that is in contact with the inner surface of the sphere 100 and a non-contact region that is separated from the inner surface of the sphere 100 by the separation distance r within a preset range. The non-contact region can be brought into contact with the inner surface of the sphere 100 depending on the rotation of the sphere 100. The contact region is coupled with the inner surface of the sphere 100 and can be brought into a non-contact state depending on the rotation of the sphere 100.

In this case, the angle of the drive body 200 with respect to the ground changes depending on the separation distance in the sphere 100, which makes various movements of the sphere 100 possible.

The arm part 260 may further have a compressible buffering portion 265 on a surface facing the inner surface of the sphere 100. If the arm part 260 has the compressible buffering portion 265 on the surface facing the inner surface of the sphere 100, the friction is reduced when the buffering portion 265 and the inner surface of the sphere 100 are in contact with each other, and the sphere 100 rotates smoothly. At this time, the buffer portion 265 is made of a non-woven fabric, but the buffer portion 265 is not limited thereto and may be made of various materials that can be compressed by only the weight of the drive body 200.

The drive body 200 further includes a control module 270 for controlling the first power supply 230 and the second power supply 240. The control module 270 includes a sensor unit 271 and a control unit 272.

The sensor unit 271 measures an acceleration value of the drive body 200. The sensor unit 271 may include a triaxial acceleration sensor capable of measuring acceleration values of three axes of the drive body 200. To that end, the sensor unit 271 may be installed at the drive body 200.

The control unit 272 recognizes a gesture corresponding to the movement of the sphere 100 based on the acceleration value measured by the sensor unit 271. Further, the control unit 272 can control the first power supply 230 and the second power supply 240 so that the sphere 100 performs a predetermined action that is mapped in advance in response to the recognized gesture. For example, the control unit 272 can be implemented as a processor such as a CPU (Central Processing Unit) or the like.

The control unit 272 recognizes any one of gestures based on the result of a comparison between the acceleration value measured by the sensor unit 271 and pre-stored reference values for a plurality of gestures. Here, the acceleration value measured by the sensor unit 271 includes a component depending on the separation distance r between the arm part 260 and the sphere 100. The reference values for the plurality of gestures include a change component of the acceleration value depending on the changes in the separation distance r between the arm part 260 and the sphere 100 due to the movement of the sphere 100.

The control unit 272 recognizes the gesture of the sphere 100 based on a first change component obtained from the changes in the acceleration value that occur in the sphere 100 by the driving force of the drive body 200. Specifically, a second change component depending on the changes in the acceleration value due to an external force applied to the sphere 100 is extracted by removing the first change component from the amount of changes in the acceleration value measured by the sensor unit 271, and any one of the gestures can be recognized based on the comparison result between the extracted second change component and the pre-stored reference values for the plurality of gestures.

Here, when the control unit 272 controls the drive body 200 to move using the first power supply unit 230 and/or the second power supply unit 240, the gesture is determined as a gesture during the movement of the sphere 100 that is related to the driving force. When the control unit 272 controls the drive body 200 to stop, the gesture is determined as a gesture during the stoppage of the sphere 100 that is not related to the driving force.

The control unit 272 can control the rotation speed and the rotation direction of the first power supply 230 and the second power supply 240 based on the gesture determination result.

The first power supply 230 and the second power supply 240 are connected to the first wheel 210 and the second wheel 220, respectively, and further provide the driving forces to the first wheel 210 and the second wheel 220, respectively. For example, the first power supply 230 and the second power supply 240 may be motors. Here, each of the first power supply 230 and the second power supply 240 can rotate in a clockwise direction or a counterclockwise direction, and the rotation speed thereof can be individually controlled.

When the first wheel 210 and the second wheel 220 of the drive body 200 are in contact with the inner surface of the sphere 100, the driving force for rotating the sphere 100 is transmitted to the sphere 100.

When the drive body 200 is stopped, both the first wheel 210 and the second wheel 220 are brought into contact with the inner surface of the sphere 100 by gravity. When the drive body 200 is rotating, the first wheel 210 or the second wheel 220 may be separated from the inner surface of the sphere 100. In other words, during the rotation, both of the regions where the sphere 100 and the drive body 200 are in contact with each other and the regions where they are separated from each other by a preset distance co-exist.

Accordingly, the sphere movable device 10 can rotate in a variety of ways depending on whether or not the first wheel 210 and the second wheel 220 are in contact with the inner surface of the sphere 100 and the angles of the first wheel 210 and the second wheel 220 with respect to the ground. For example, when the wheels of the drive body 200 are rotating in the same direction at the same speed, the sphere 100 rolls forward. Since, however, the drive body 200 is not in firm contact with the sphere 100, the drive body 200 shakes in the sphere 100, which may result in uneven forward movement of the sphere 100.

The arm parts 260 have a function of balancing the drive body 200. However, due to a predetermined distance between the arm parts 260 and the inner surface of the sphere 100, some of the arm parts 260, the first wheel 210 and the second wheel 220 may be separated from the inner surface of the sphere 100 during the rotation of the sphere 100.

Accordingly, although the drive body 200 in the stopped state can be positioned perpendicular to the ground in the sphere 100, the drive body 200 may move in the sphere 100 at an angle with respect to the ground that is different from that in the stopped state depending on the rotation of the sphere 100.

At this time, if the predetermined distance between the arm part 260 and the inner surface of the sphere 100 is greater than or equal to 0.5 mm and smaller than or equal to 2 mm, the angle of the drive body 200 with respect to the ground changes, making various movements of the sphere 100 possible.

When the distance is less than 0.5 mm, the distance between the arm part 260 and the inner surface of the sphere 100 is small. Therefore, the drive body 200 is brought into firm contact with the inner surface of the sphere 100. Accordingly, the sphere 100 can only rotate forward or backward.

When the distance is greater than 2 mm, the distance between the arm part 260 and the inner surface of the sphere 100 is wide, which makes the movement range of the drive body 200 in the sphere 100 irregular. Accordingly, it is not possible to consistently control the rotation of the sphere 100.

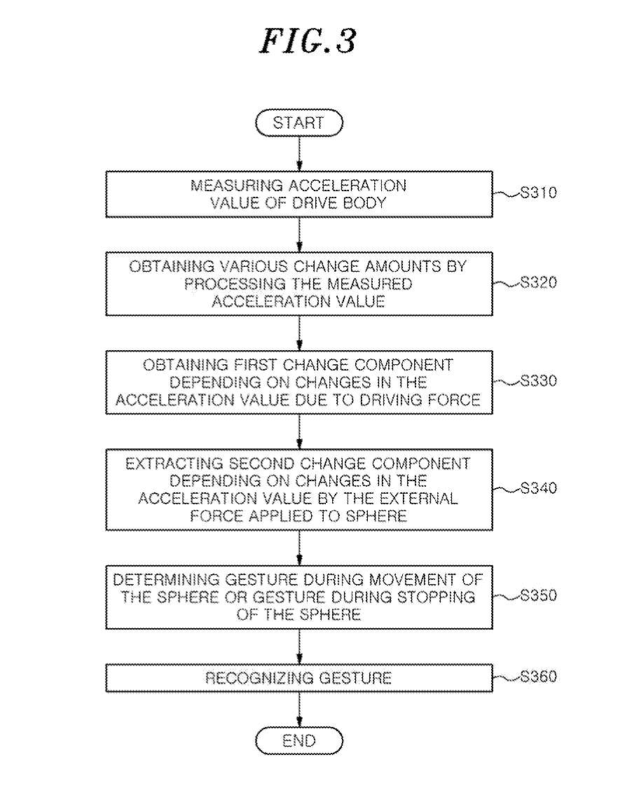

FIG. 3 is a flowchart for explaining a gesture recognition method of the spherical movable device 10 according to one embodiment of the present disclosure.

Referring to FIGS. 1 to 3, the sensor unit 271 of the drive body 200 measures the acceleration value of the drive body 200 and provides the measured acceleration value to the control unit 272 (S310). For example, the acceleration values of the x-axis, the y-axis, and the z-axis of the drive body 200 can be measured by using a triaxial acceleration sensor.

Here, the sphere 100 and the drive body 200 are loosely coupled so that both the contact region and the non-contact region can exist between the sphere 100 and the driver 200, and the contact region and the non-contact region can be switched. Therefore, the movement characteristics change in various ways compared to the coupling state, in which the sphere 100 and the drive body 200 are compressed to be in constant contact with each other during movement. Accordingly, relatively more abundant movement status information, including the acceleration value and its change component, is measured. This is because the movement status information includes a component depending on the separation distance r between the arm part 260 and the sphere 100.

Further, since the sphere 100 and the drive body 200 are loosely coupled during movement, the movement status information, including the acceleration value measured at this time and its change component, is reliable.

The control unit 272 obtains various change amounts by processing the acceleration value provided from the sensor unit 271 (S320). For example, the control unit 272 can obtain a minimum/maximum value for each section, an average value for each section, a vector value of force for each section, (mean) variance/distribution for an each section, overall minimum/maximum value, an overall average value, an overall vector value of force, an overall (mean) variance/distribution, cycle of occurrence of the changes, the amount of changes in the horizontal and the vertical direction, the amount of changes at the time of free fall, and the like.

The control unit 272 obtains the first change component depending on the changes in the acceleration value due to the driving force of the drive body 200 (S330). Specifically, the control unit 272 is obtaining the acceleration value corresponding to the movement component and its change component, where the movement component is provided by the driving force from the drive body 200 and not by an external force applied to the sphere 100.

Since the control unit 272 controls the movement of the driver 200 by controlling the rotation speeds and the rotation directions of the first power supply 230 and the second power supply 240, it is possible to estimate and recognize the movement characteristics, i.e., types of movement, of the sphere 100 by the drive body 200. The acceleration value and its change component due to the drive body 200, measured for each type of movement of the sphere 100 in the environment where the external force is not applied to the sphere 100, are collected, registered and stored in advance. The control unit 272 can obtain the acceleration value and its change component of the sphere 100, corresponding to the movement component by the driving force provided from the drive body 200, by reading out the acceleration value and its change component corresponding to the type of movement currently executed by the sphere 100 among the plurality of pre-stored types of movement. Here, the acceleration value and its change component registered and stored in advance include a component depending on the separation distance r between the arm part 260 resulting from the movement of the sphere 100 and the sphere 100.

Next, the control unit 272 extracts the second change component depending on the changes in the acceleration value due to the external force applied to the sphere 100 by removing the first change component obtained in step S330 from the overall change amount of the acceleration value measured by the sensor unit 271. In other words, only the change component of the acceleration value, due to the external force applied to the sphere 100 by a specific gesture executed by an object that can apply an external force to the sphere 100, is extracted (S340).

One of the gestures from a plurality of gestures can be recognized based on the comparison result between the second change component extracted in step S340, i.e., the amount of changes in the acceleration value due to the external force applied to the sphere 100, and the pre-stored reference values for the plurality of gestures. Here, the reference values for the plurality of gestures are obtained by previously collecting, registering and storing the acceleration value and its change component of the drive body 200 for each gesture due to the external force in an environment where an external force is applied to the sphere 100. However, when the movement component of the gesture during movement of the sphere 100 and the movement component of the gesture during stoppage of the sphere 100 have similar patterns, it is difficult to distinguish the gesture during movement and the gesture during stoppage by only comparing the reference values of the plurality of gestures.

The gestures executed by the external force applied to the sphere 100 may include touch, jab, punch, kick, drop, lift, juggle, shake, catch, bump, bump-lean, and the like. Bump can be defined as a movement characteristic in which the sphere 100 bumps into an obstacle. Bump-lean can be defined as a movement characteristic in which the sphere 100 that has bumped into an obstacle keeps moving forward and pushes the obstacle without bouncing off. While bump and bump-lean can occur due to an obstacle that is fixed, such as a wall or the like, since an object that moves by itself can move to a specific position and serve as an obstacle, bump and bump-lean can be recognized as gestures executed by an external force. Among the above-described gestures, jab, punch, kick, bump and the like have similar movement component patterns. Therefore, it is difficult to identify whether the sphere 100 is moving or stopped only by comparing the previously registered and stored reference values for the plurality of gestures.

Accordingly, when the control unit 272 controls the drive body 200 to move using the first power supply unit 230 and/or the second power supply unit 240, the gesture is determined as a gesture during the movement of the sphere 100 that is related to the driving force. When the control unit 272 controls the drive body 200 to stop, the gesture is determined as a gesture during the stoppage of the sphere 100 that is not related to the driving force (S350).

Next, the control unit 272 recognizes one of the gestures based on the comparison result between the second change components extracted in step S340, i.e., the amount of changes in the acceleration value due to the external force applied to the sphere 100, and the pre-stored reference values of the plurality of gestures. Here, the pre-stored reference values for the plurality of gestures include the change component depending on the separation distance r between the arm part 260 and the sphere 100 due to the movement of the sphere 100. When it is determined in step S350 that the sphere 100 is moving, one of the gestures during movement is recognized, and when it is determined in step S350 that the sphere 100 is stopped, one of the gestures during stoppage is recognized.

For example, in the case of bump and kick, it is difficult to accurately distinguish the gestures based only on the comparison result between the second change component extracted in step S340 and the reference values for the plurality of gestures. Here, the case in which the control unit 272 recognizes bump or kick based on the comparison result between the second change component and the reference values for the plurality of gestures will be described. When the first power supply 230 and/or the second power supply 240 are controlled to stop, the control unit 272 determines the gesture at this time to be kick. When the first power supply 230 and/or the second power supply 240 are controlled to move, the control unit 272 determines the gesture to be kick if a specific pattern such as a jump pattern, a levitation pattern or the like is included in the second change component extracted in step S340, and determines the gesture to be bump if a specific pattern is not included in the second change component (S360).

As described above, in the spherical movable device 10 according to the embodiment of the present disclosure, the drive body 200 and the sphere 100 are loosely coupled so that a contact region of the drive body 200 where the drive body 200 makes contact with the sphere 100 may not make contact with the sphere 100 depending on a movement, or a non-contact region of the drive body 200 where the drive body 200 does not make contact with the sphere 100 may make contact with the sphere 100 depending on a movement. Therefore, the movement characteristics change in a variety of ways compared to a coupled sphere movable device in which the sphere and the drive body are compressed to be in constant contact with each other during movement. Accordingly, relatively more abundant movement status information, including the acceleration value and its change component, is measured. In addition, since the sphere 100 and the drive body 200 maintain the loosely coupled state during movement, the movement status information, including the acceleration value measured at this time and its change component, is reliable.

Therefore, the gestures of the spherical movable device can be recognized based on the abundant and reliable movement status information, making it possible to recognize the various gestures with high accuracy.

Combinations of blocks in the flowcharts of the present disclosure can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the steps of the flowchart. These computer program instructions may also be stored in a computer usable or computer readable memory that can direct a computer or other programmable data processing apparatuses to function in a particular manner, such that the instructions stored in the computer usable or computer readable medium can produce an article of manufacture including instructions which implement the function specified in the blocks of the flowcharts. The computer program instructions may also be loaded onto a computer or other programmable data processing apparatuses to cause a series of operational steps to be performed on the computer or other programmable apparatuses to produce a computer implemented process such that the instructions which execute on the computer or other programmable apparatuses provide processes for implementing the functions specified in the blocks of the flowcharts.

Each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A spherical movable device comprising:
a sphere having an inner space;
a drive body provided in the inner space and configured to provide a driving force for rotating the sphere, the drive body including a contact region where the drive body is in contact with an inner surface of the sphere and a non-contact region where the drive body is separated from the inner surface of the sphere by a separation distance within a preset range, the non-contact region being brought into contact with the inner surface of the sphere depending on the rotation of the sphere;
a sensor unit configured to measure an acceleration value of the drive body; and
a control unit configured to recognize a gesture corresponding to a movement of the sphere based on the acceleration value including a component depending on the separation distance.

2. The spherical movable device of claim 1, wherein the control unit recognizes any one of a plurality of gestures based on a comparison result between the acceleration value measured by the sensor unit and pre-stored reference values for the plurality of gestures, and
the reference values include a change component of the acceleration value depending on changes in the separation distance due to movement of the sphere.

3. The spherical movable device of claim 1, wherein the control unit obtains a first change component depending on changes in the acceleration value due to the driving force, the control unit extracts a second change component depending on changes in the acceleration value due to an external force applied to the sphere by removing the first change component from the amount of changes in the acceleration value measured by the sensor unit, and the control unit recognizes one of a plurality of gestures based on a comparison result between the extracted second change component and pre-stored reference values for the plurality of gestures.

4. The spherical movable device of claim 3, wherein when the control unit controls the drive body to move, the gesture is determined as a gesture during movement of the sphere that is related to the driving force, and when the control unit controls the drive body to stop, the gesture is determined as a gesture during stoppage of the sphere that is not related to the driving force.

5. The spherical movable device of claim 4, wherein when any one of bump and kick is recognized based on a comparison result between the second change component and the reference values for the plurality of gestures, the control unit determines the gesture to be kick during stop control.

6. The spherical movable device of claim 4, wherein when any one of bump and kick is recognized based on a comparison result between the second change component and the reference values for a plurality of gestures, the control unit determines the gesture to be kick if a specific pattern is included in the second change component during the movement control and determines the gesture to be bump if the specific pattern is not included in the second change component.

7. A gesture recognition method of a spherical movable device including a sphere having an inner space, and a drive body provided in the inner space and configured to rotate the sphere,
wherein the drive body includes a contact region where the drive body is in contact with an inner surface of the sphere and a non-contact region where the drive body is separated from the inner surface of the sphere by a separation distance within a preset range, and the non-contact region is brought into contact with the inner surface of the sphere depending on a rotation of the sphere,
the gesture recognition method comprising:
measuring an acceleration value of the drive body; and
recognizing a gesture corresponding to a movement of the sphere based on the acceleration value including a component dependent upon the separation distance.

8. The gesture recognition method of claim 7, wherein in said recognizing gesture, any one of a plurality of gestures is recognized based on a comparison result between the acceleration value measured by a sensor unit and pre-stored reference values for the plurality of gestures, and
the reference values include a change component of the acceleration value depending on changes in the separation distance due to movement of the sphere.

9. The gesture recognition method of claim 7, wherein in said recognizing gesture, a first change component depending on changes in the acceleration value due to the driving force is obtained, a second change component depending on changes in the acceleration value due to an external force applied to the sphere is extracted by removing the first change component from the amount of changes in the measured acceleration value, and one of a plurality of gestures is recognized based on a comparison result between the extracted second change component and pre-stored reference values for the plurality of gestures.

10. The gesture recognition method of claim 9, wherein in said recognizing gesture, when the drive body is controlled to move, the gesture is determined as a gesture during movement of the sphere that is related to the driving force, and when the drive body is controlled to stop, the gesture is determined as a gesture during stoppage of the sphere that is not related to the driving force.

11. The gesture recognition method of claim 10, wherein in said recognizing gesture, when any one of bump and kick is recognized based on a comparison result between the second change component and the reference values for the plurality of gestures, the gesture is determined to be kick during stop control.

12. The gesture recognition method of claim 10, wherein in said recognizing gesture, when any one of bump and kick is recognized based on a comparison result between the second change component and the reference values for the plurality of gestures, the gesture is determined to be kick if a specific pattern is included in the second change component during the movement control and determined to be bump if the specific pattern is not included in the second change component.
